(19) United States
(12) Patent Application Publication
(10) Pub. No.: US 2021/0216820 A1
(43) Pub. Date: Jul. 15, 2021

(54) Context Modeling in User Behavior Learning

(71) Applicant: Bayerische Motoren Werke Aktiengesellschaft, Muenchen (DE)

(72) Inventors: Wangsu HU, Chicago, IL (US); Jilei TIAN, Chicago, IL (US)

(21) Appl. No.: 16/743,099

(22) Filed: Jan. 15, 2020

(51) Int. Cl. G06K 9/62; H04L 29/08; G06F 16/9535; B60W 40/09

(52) U.S. Cl. CPC G06K 9/6257; B60W 40/09; G06F 16/9535; H04L 67/22

(57) ABSTRACT

A system, method and non-transitory computer-readable medium provided an algorithmic framework for context modeling of user behavior and machine learning of the user behavior in order to optimize user behavior across users, context, and content with different kinds of behaviors. According to the algorithmic framework, context and content modeling optimizes user behavior across users, context, content with different kind of behaviors based on a user behavior matrix.

### BACKGROUND AND SUMMARY OF THE INVENTION

The present invention relates to a system, method and non-transitory computer-readable medium for context modeling of user behavior and machine learning of the user behavior in order to optimize user behavior across users, context, and content with different kinds of behaviors.

User behavior is commonly defined as the user's predictable pattern for a given context. Thus, context modeling plays a critical role in user behavior learning. Context modeling can be used in user segmentation, recommendation, and other contextual and personal services. For a next trip prediction, it would be significant if we were able to model the temporal and spatial information with rich semantics based on user behavior, so we are able to predict the user's next trip anywhere and anytime.

Machine learning can be used to learn user behavior from the data, and thus predict a next destination, trip and route. With machine learning, a vehicle can be preconditioned before a trip, a user can be notified of the right time to leave based on real time traffic, and setup of navigation can be assisted right before the trip. Further, relevant traffic information can be updated during the driving along a route, relevant information about the predicted destination can be suggested, e.g., parking, alternative route and last mile information. In the contextual and personal service, it is highly expected to model the context, e.g., temporal and spatial information, being able to model user behavior, and then build a predicted model. The present invention proposes an effective algorithmic framework for context modeling based on user behavior in which the prediction is the objective.

The most commonly used context information is time and location, also called temporal and spatial information. There is a difficulty in modeling this context information, however, due to sparse data in large temporal and spatial space. An association rule mining approach has been applied to predict a user's trip, but it has a limited ability to predict the user's next destination due to lack of contextual modeling covering all the time and locations, as well as their semantics.

Sentiance has developed a deep learning based solution that is trained to encode geo-spatial relations and semantics similarities describing a location's surroundings. See, e.g., https://www.sentiance.com/2018/05/03/venue-mapping/. A challenge with this solution, however, is that the location is semantically modeled by geographical similarity without taking the user's interaction and behavior into account, which limits the performance of the user experience.

Though there are some known instances of context embedding, such as location, known forms of context embedding do not provide an algorithmic framework for context and content modeling that aims to optimize user behavior across users, context, content with different kind of behaviors. The present invention provides such an algorithmic framework. With context modeling, a system is able to better understand the user's context and behavior, and provide and improve the contextual and personal experience, e.g., recommendation, prediction, user segmentation, and other contextual and personal services. The approach proposed herein is a novel and effective algorithmic solution for modeling rich semantics of context and content across users with different kind of behaviors.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a high-level framework for user behavior modeling according to the present invention.

FIG. 2 illustrates a schematic block diagram of a system according to an exemplary embodiment of the present invention.

FIG. 3 illustrates a method according to an exemplary embodiment of the present invention.

FIG. 4 illustrates an exemplary embodiment of a linear transformation to generate a user behavior record.

FIG. 5 illustrates an exemplary embodiment of a user behavior matrix according to the present invention.

FIGS. 6A and 6B graphically illustrate experiment results of context embedding or modeling before and after training, respectively.

### DETAILED DESCRIPTION OF THE DRAWINGS

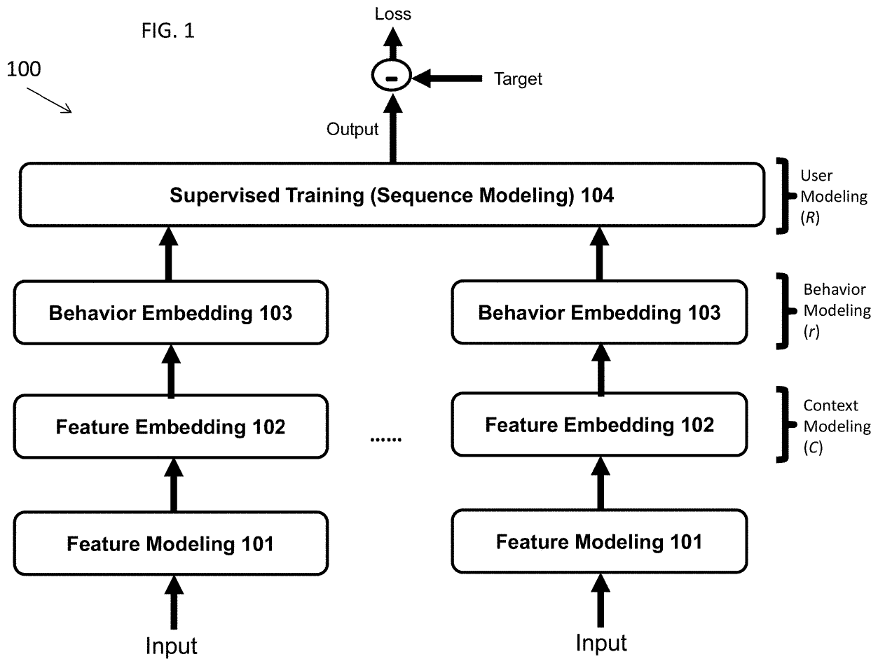

FIG. 1 illustrates a high-level framework for user behavior modeling 100 according to the present invention. For the data collected across users, the system processes the data into features, organized by context embedding layer, user behavior embedding layer and user embedding layer. The system is trainable based on the loss defined by the prediction task, e.g., predicted destinations. As illustrated in FIG. 1, feature modeling 101, feature embedding 102, and behavior embedding 103 are performed and then outputs from these processes are received and processed by the supervised training (sequence modeling) 104 to provide a system output, which is compared to a target to produce a loss. An object of the present invention is to minimize this loss.

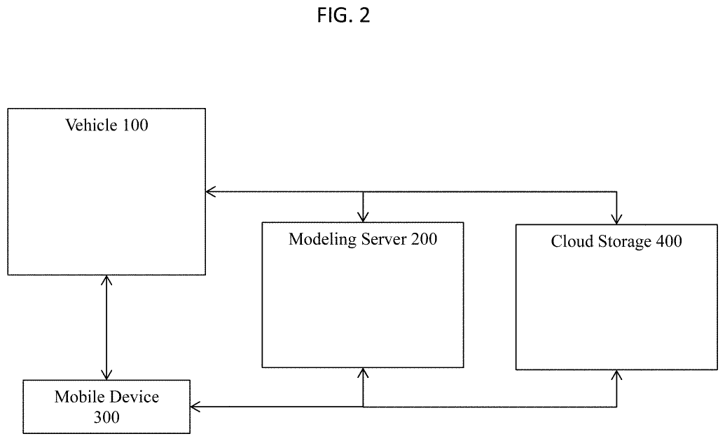

FIG. 2 illustrates a schematic block diagram of a system according to an exemplary embodiment of the present invention. The system may include, for example, a vehicle 100, a modeling server 200, a mobile device 300, and cloud storage 400. Each of these devices has its own processor and memory and a communication interface(s), wherein the processors are specifically programmed to perform the functions described herein. Telemetry data and the like may be received from the vehicle 100 and may be received from the mobile device 300. The mobile device 300 may be a smart phone, tablet computer or the like. Communication between the modeling server and the vehicle/mobile device may occur via cellular network, WiFi, Bluetooth, or the like. Data gathered from the vehicle 100 and the mobile device 300 may be transmitted to the modeling server 200 or transmitted directly to cloud storage 400.

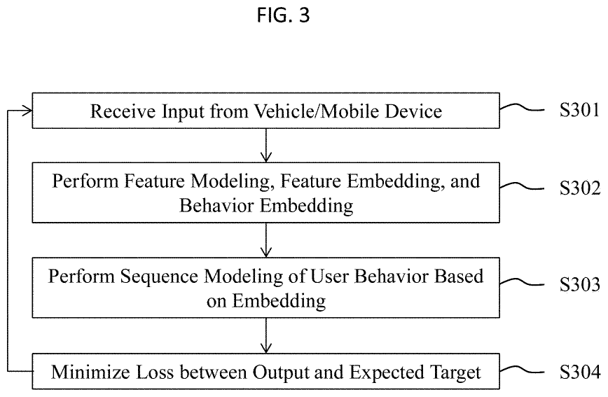

FIG. 3 illustrates a method according to an exemplary embodiment of the present invention. In step S301, an input from a vehicle and/or mobile device is received. The input is processed by the system (i.e., modeling server 200) to perform feature modeling, feature embedding, and behavior embedding of the inputs in step S302. The sequence modeling of the user behavior is then performed in step S303 based on the results of the feature modeling, feature embedding, and behavior embedding. The sequence modeling results in an output in step S304, in which the loss between the output and the expected target are compare and minimized, and the process may be repeated any number of times in order to reduce the amount of error (loss) in the user modeling. During an initial learning phase, the processes may be repeated any desired number of times in order to produce an output with a desired level of accuracy.

User behavior is defined as taking certain action on certain content in a given context, e.g., drive to a destination for a given date, time, location, etc., or purchase an item for a given date, time, location and other context or desire. User interactions are further described below.

An interaction record is an item in the interaction set T={I₁, I₂, . . . , }, where Iₙ(1≤n≤Q) denotes a kind of user interaction such as departure, arrive, purchase, etc. Content O is a set of items that the user interaction is applied on, let O={O₁, O₂, . . . , O_{K}} where Oₙ(1≤n≤K) represents a content such as an item.

With regard to context, given a contextual feature, set F={f₁, f₂, . . . , f_{P}} a context Ci is a group of contextual feature-value pairs, i.e., Ci={(x₁:v₁), (x₂:v₂), . . . , (x_{L}:v_{L})}, where xⱼϵF and vₙ is the value for xₙ(1≤n≤L).

A user behavior record (instance) rᵢ=<Iᵢ, Oᵢ, Cᵢ> is composed of a user interaction from interaction, content and context denoted as I, O and C. A user behavior matrix R=(r₁ r₂ . . . r_{T})ₜ, where R is a sequence of user behavior records ordered by timestamps. User modeling is a learned user pattern from user behavior matrix R.

Feature modeling is further described below. User behavior is defined as taking certain action on certain content in a given context. All user interaction I, content O, and context C are modeled to construct the feature modeling layer consisting of the raw input.

In order to give a quantitative analysis of user interaction/content/context, representation learning is applied to generate an “embedding” vector for different objects. An embedding is a mapping of a discrete categorical variable to a vector of continuous numbers. The semantic distance or similarity between different objects such as two locations, two users, two words or sentences, or even two timestamp can be determined from the embedding. Normally, embedding can be trained in a data-driven framework to preserve the semantic meaning of objects.

For a trip prediction task, for example, we assume we have the user interaction set {I1, I2, . . . , }, content set {O1, O2, . . . , OK}, and context set {C1, C2, . . . , CP}. The embedding matrix of the raw features can be modeled as follows:

E({I})=[[I_{1,1},I_{1,2}, . . . ,I_{1,H}], . . . ,[I_{Q,1},I_{Q,2}, . . . ,I_{Q,H}]]

E({O})=[[O_{1,1},O_{1,2}, . . . ,O_{1,H}], . . . ,[O_{K,1},O_{K,2}, . . . ,O_{K,H}]]

E({C})=[[C_{1,1},C_{1,2}, . . . ,C_{1,H}], . . . ,[C_{P,1},C_{P,2}, . . . ,C_{P,H}]]

where H is the pre-defined feature size of the embedding vector, and Q, K, P is the size of user interaction, content, and context, respectively. Both of the time and location information associated with the user behavior may be represented, for example, by a 128 dimension space.

The context embedding is further described below. In the feature embedding layer, our goal is, given the raw input consisting of an index of interaction embedding I, content embedding O, and context embedding C, to construct the feature embedding layer for behavior record r. Let a tuple (q, k, p) be the input so that each element is the lookup index of user interaction I, content O, and context C respectively. The feature embedding is represented by a (3, H)-size matrix where each row is a (1, H)-size vector extracted from different embedding matrix based on the index q, k, p, where H is, for example, 128. To simplify the understanding, we just use one embedding for content and one for context, but this can be extended to multiple context and content embeddings. We applied linear transformation to generate the behavior record r as feature embedding as follows:

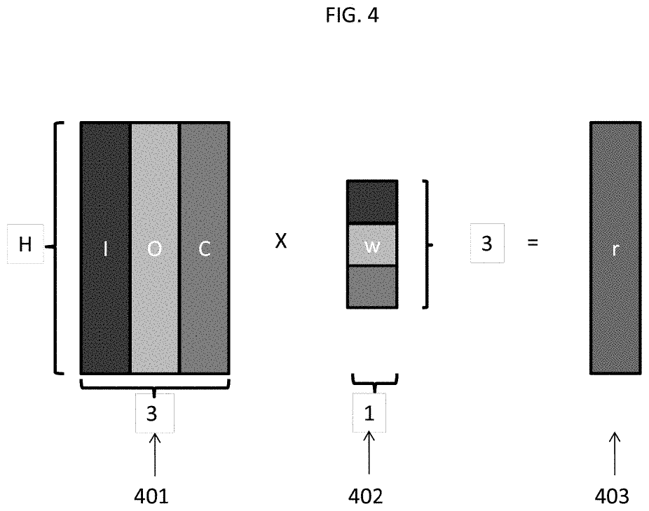

r=concatenateₐₓᵢₛ₌₁(E(I_{q}),E(Oₖ),E(Cₚ))×w+b

where concatenateₐₓᵢₛ₌₁ ( ) is an operation that concatenates the three (1, H)-size vectors along axis 1 to generate a (3, H)-size matrix, and w and b are linear transformation parameters that need to be trained. This feature is illustrated in FIG. 4, which illustrates the (3, H)-size matrix 401, the liner transformation parameters 402 and the resulting behavior record 403.

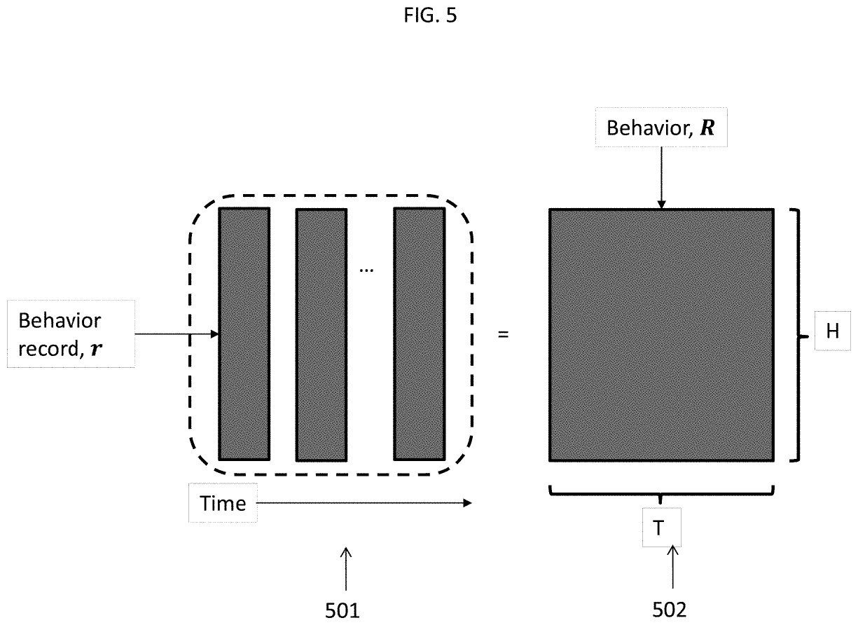

The behavior embedding is further described below. Given user's behavior record r through behavior modeling, we have user behavior R that consists of a sequence of user behavior record ordered by timestamps. Assume the user has T number of behavior records, we concatenate all r 501 along axis t to generate a (H, T)-size matrix 502: R=(r₁ r₂ . . . r_{T})ₜ, as shown in FIG. 5.

The supervised training is further described below. Once we have the user behavior matrix R that is (H, T)-size, we can apply a self-attention-mechanism based network to train the network by optimizing the objective function for a given task. A self-attention mechanism was introduced by Google in 2017 that can learn the representation learning (embedding) of sequential input. Using this framework, natural language understanding can be used and surrounding words can give context and influence each other in attention modeling. Using the self-attention mechanism, the calculation of user embedding layer is simplified as follows:

f(Q,Kᵢ)=Q^{T}Kᵢ

aᵢ=softmax(f(Q,Kᵢ))=exp(f(Q,Kᵢ))/(Σⱼ exp(f(Q,Kⱼ))

Attention(Q,K,V)=ΣᵢaᵢVᵢ

where Q, K, V represents the query, key, value separately that are concepts used in the attention mechanism, and here Q=K=V=R. After calculation, the output is a (H, H)-size matrix that represents personal feature used for supervised training for a given task. Thus, we have a fixed-length personal feature that can be fed into the downstream task training. In our experiment, we apply this approach for predicted destination.

As described below, telemetry and annotation are used as an example application of the above-described modeling. User ID-based, user permission is required to cope with user privacy and General Data Protection Regulation (GDPR). In this example, all data is transmitted directly into cloud storage. Data is gathered from mobile devices (e.g., mobile phones) and vehicles. The location from mobile phones (e.g., iOS, Android phones) is represented as “Geofence” including latitude/longitude (lat/lon) and a timestamp of entering and leaving of a given location. Location tracking of the mobile devices may include, for example, lat/lon, timestamp, and update when having significant movement or at a sampled time interval.

Telemetry and location may also be obtained from vehicles, wherein location tracking may include, for example, lat/lon, timestamp, and update when having significant movement or at a sampled time interval. The telemetry data may be annotated. For example, all data may be annotated by the source (phone or vehicle), user and vehicle ID if applicable, time stamp, and the like.

According to another example, a predicted trip may be determined based on the above-described modeling. In one use case, a request and a response by application programming interface (API) are provided. This may include smart search, in which the destination(s) a user searches in the app are recommended and/or smart navigation, in which top possible destinations are recommended when the user starts to drive, based on the user and user's context. Alternatively, the user behavior matrix can be used to recommend music, movies, apps, and the like to particular users.

In another use case, a notification by push to the user's device(s) is implemented. For example, a time-to-leave notification, informing the user when to leave to arrive at a desired time due to real time traffic change may be pushed to the user. Also, smart preconditioning, in which the user is reminded to precondition their vehicle or the vehicle is automatically preconditioned 30 minutes before the trip (e.g., heating/cooling), may be implemented.

According to an experiment performed by the inventors, the deployment of the proposed model on trip pattern prediction task that predicts which location user will visit at certain time given his/her trip history was explored. The dataset includes user location tracking including driving. Raw features of the experiment include: user ID, location_gps_grid_ID, timestamp, 200 users, 5000 locations through a 200 m×200 m grid by map segmentation, performed over a 6-month period. We assume we have a user interaction for user u to be={(visit location i₀ at time t₀), . . . , (visit location i_{T} at time T_{T})}. We use the first k of Iᵤ to predict the k+1-th visit in the training set, where data contains both location i and timestamp t information for the visit, and we use the first n−1 visit to predict the last one in the test set.

We model the context feature through introducing three different types of object embedding for location, hour of day, day of week, respectively. We reported the top N-best matching accuracy that is widely used in a recommendation system to measure the performance. It correctly returns 1 for top N matching if the recommended item is within the top N results based on a set of M items ranked by the predicted preference of a user. The results are shown below.
1-best matching: 0.79 (first prediction)
2-best matching: 0.90 (top 2 prediction)
3-best matching: 0.94 (top 3 prediction)

The result shows a promising potential of deploying user behavior learning framework to support downstream prediction task.

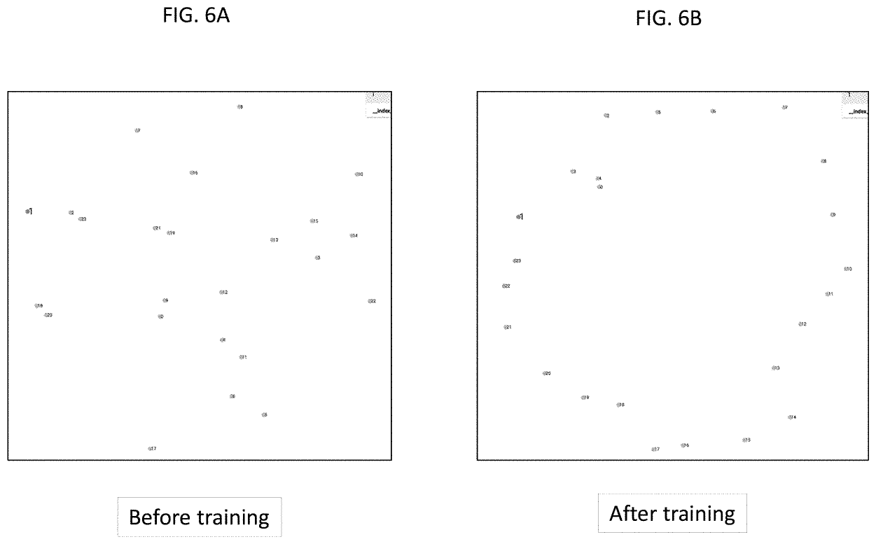

FIGS. 6A and 6B graphically illustrate the results of the context embedding or modeling before and after training, respectively, from the above-described experiment. Here, we use hour-of-day embedding as an example for illustration. Through a dimension reduction by principle component analysis, we visualize the embedding before and after training. Before training the data appears random, but after the training a logical pattern emerged. The hour-of-day embedding matrix is formatted as (24, 128) size for 24 hour per day and 128 embedding dimensions. After dimension reduction, we found out it preserves consistent semantics against our common sense where a 24 hour index is clock-wisely distributed. The result shows that, although the embedding is trained through a trip prediction task (supervised training) rather than itself (unsupervised training), the training can output the meaningful embedding of an object which can become significant features for the downstream task.

In another exemplary embodiment of the present invention, a non-transitory computer-readable medium is encoded with a computer program that performs the above-described method. Common forms of non-transitory computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, or any other medium from which a computer can read.

The present invention provides a number of significant advantages over conventional systems and methods. The present invention provides the predicted trip algorithm framework that supports notification-based and request-based use cases and scenarios. Due to the embedding framework, the information provided to the user is enriched by temporal and spatial context modeling by measuring the similarity (e.g., home or office) among different users from different places, and by inferring improved predictions from time, location and trip.

The present invention provides an algorithm that can achieve the following benefits: low complexity, which improves the service online computation; improved user experience by leveraging personal context to have better predicted performance; and a technical solution to address data sparsity. Further, the predictive performance is improved by addressing the fine granularity of personal context and the coarse granularity of data sparsity. The algorithm according to the present invention is able to extend to other contexts, behaviors and services. Additionally, the present invention enables more smart services, e.g. smart search, smart preconditioning, smart charging, time-to-leave, except the predicted trip for smart navigation. For the predicted destination, arrival time and route, the present invention is able to provide to the user richer information about traffic and happenings along the route, reserve the parking and restaurant, etc., all around the destinations, as well as provide deal recommendations, local pedestrian map for the last mile of a trip or connected transportation service, and the like.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for performing user behavior modeling of a user, comprising:
receiving a user behavior input from the user, the user behavior being defined by an action on a content in a context;
performing feature modeling, context modeling, and behavior modeling on the received user behavior input to produce indexes of interaction, content and context, respectively;
generating a behavior record based on the indexes of interaction, content and context; and
generating a user behavior matrix based on a sequence of user behavior records generated over time.

2. The method according to claim 1, further comprising applying a self-attention mechanism to the user behavior matrix to produce a personal feature matrix for the user.

3. The method according to claim 1, wherein the interaction is driving a vehicle, the content is a location of the vehicle, and the context is a date and time of the driving.

4. The method according to claim 1, wherein the interaction is purchasing an item, the content is a location of purchase, and the context is a date and time of the purchase.

5. The method according to claim 1, further comprising:
receiving a destination search input from the user; and
outputting predicted destinations to the user based on the destination search input and the user behavior matrix.

6. The method according to claim 3, further comprising:
transmitting a notification to the user of a predicted time to start driving the vehicle in order to reach a destination on time, based on the user behavior matrix and real time traffic information.

7. The method according to claim 3, further comprising:
transmitting a reminder to the user to precondition the vehicle with heating or cooling a predetermined amount of time before a scheduled trip of the user based on the user behavior matrix.

8. The method according to claim 3, further comprising:
automatically preconditioning the vehicle with heating or cooling a predetermined amount of time before a scheduled trip of the user based on the user behavior matrix.

9. A non-transitory computer-readable medium storing a program that, when executed by a processor, causes the processor to perform a method comprising:
receiving a user behavior input from the user, the user behavior being defined by an action on a content in a context;
performing feature modeling, context modeling, and behavior modeling on the received user behavior input to produce indexes of interaction, content and context, respectively;
generating a behavior record based on the indexes of interaction, content and context; and
generating a user behavior matrix based on a sequence of user behavior records generated over time.

10. The non-transitory computer-readable medium according to claim 9, further comprising applying a self-attention mechanism to the user behavior matrix to produce a personal feature matrix for the user.

11. The non-transitory computer-readable medium according to claim 9, wherein the interaction is driving a vehicle, the content is a location of the vehicle, and the context is a date and time of the driving.

12. The non-transitory computer-readable medium according to claim 9, wherein the interaction is purchasing an item, the content is a location of purchase, and the context is a date and time of the purchase.

13. The non-transitory computer-readable medium according to claim 9, further comprising:
receiving a destination search input from the user; and
outputting recommended destinations to the user based on the destination search input and the user behavior matrix.

14. The non-transitory computer-readable medium according to claim 11, further comprising:
transmitting a notification to the user of a recommended time to start driving the vehicle in order to reach a destination on time, based on the user behavior matrix and real time traffic information.

15. The non-transitory computer-readable medium according to claim 11, further comprising:
transmitting a reminder to the user to precondition the vehicle with heating or cooling a predetermined amount of time before a scheduled trip of the user based on the user behavior matrix.

16. The non-transitory computer-readable medium according to claim 11, further comprising:
automatically preconditioning the vehicle with heating or cooling a predetermined amount of time before a scheduled trip of the user based on the user behavior matrix.
